(19) United States
(12) Patent Application Publication
(10) Pub. No.: US 2002/0140279 A1
(43) Pub. Date: Oct. 3, 2002

(54) Seat belt for pregnant women

(76) Inventors: Yehuda Arditi, Rishon Lezion (IL); Chen Goldchmit, Rishon Lezion (IL)

Correspondence Address: Dr Mark Friedman LTD, c/o Bill Polkinghorn Discovery Dispatch, 9003 Florin Way, Upper Marlboro, MD, 20772, US

(21) Appl. No.: 09/820,628

(22) Filed: Mar. 30, 2001

(51) Int. Cl. B60R 21/00

(52) U.S. Cl. 297/485

(57) ABSTRACT

A retaining system for retaining an individual against inertial forces while sitting in a seat of a vehicle includes a connecting element for deploying across the width of the rear surface of the seat back support, and two retaining straps, each attached to a side of the connecting element so as to provide a loop through which an arm of the individual can be inserted. A catch assembly is provided for releasable connecting between the two retaining straps so as to allow closure of the retaining system around the chest of the individual.

### FIELD AND BACKGROUND OF THE INVENTION

The present invention relates to an individual body-restraining device for protection of an occupant of a transport vehicle and, in particular, it relates to a seat belt designed to protect pregnant women in the event of an automobile accident.

It is known that the existing safety seatbelt does not provide the pregnant woman satisfactory protection to her and her embryo during a car accident. The mechanical pressure, which is inflicted by the seatbelt on the abdomen of the pregnant woman, may cause damage to the placenta such as separation of the placenta or to the embryo such as cerebral hemorrhaging.

According to New York State's occupant restraint law “Pregnant women should always wear seat belts to protect both the expectant mother and her unborn child. Make sure the lap belt is low on the hips, under the unborn child, and the shoulder belt is resting across the chest and shoulder.”

It is the law in many countries that all passengers including pregnant women are obligated to wear a safety belt.

In prior art there are almost two thousand patents and designs describing various aspects of seat belts none of which deal with the safety hazard that the basic design of the shoulder belt presents to the pregnant women especially in the latter two trimesters of pregnancy. US D 432290 to Mc. Comb deals with a seat belt lap pillow and positioner for use by pregnant women, which like similar ones, do not deal with the safety hazard involved with the shoulder strap to pregnant women.

Finally, reference is made to U.S. Pat. No. 5,215,354 to Grene which discloses a removable vehicle safety restraint for pregnant women which is formed from a number of straps. Specifically, the upper torso of the woman is retained by loops for encircling the shoulders which are attached, behind the shoulders, to a belt around the chair.

While apparently providing various advantages, the device proposed by Grene suffers from severe shortcomings which render it at least uncomfortable and probably also unsafe. Since the shoulder loops are attached at a midpoint behind the shoulder, a sudden forward impulse caused by a collision would result in deformation of the shoulder loops into elongated an narrow shape, thereby applying potentially damaging forces to the upper and lower surfaces of the shoulders.

There is therefore a need for a safety belt which is adapted to the pregnant woman which will remain comfortable and be easily detachable while retaining utmost safety.

### SUMMARY OF THE INVENTION

The present invention is an individual body restraining device for protection of an occupant of a transport vehicle and, in particular, it relates to a seat belt designed to protect pregnant women in the event of a automobile accident.

According to the teachings of the present invention there is provided; a retaining system for retaining an individual against inertial forces while sitting in a seat of a vehicle, the seat having a back support with a front surface against which the individual sits and a rear surface, the rear surface having a width. The retaining system includes at least one connecting element configured for deploying across the width of the rear surface of the back support, the at least one connecting element including a first side portion and a second side portion and two retaining straps, each of the retaining straps being connected to or integrally formed with one of the first and second side portions at a first attachment point at a first vertical position and at a second attachment point vertically spaced from the first attachment point, each of the retaining straps thereby forming a loop through which an arm of the individual can be inserted; and a catch assembly including at least one catch portion attached to one of the retaining straps, the catch assembly being configured for releasable connecting between the two retaining straps so as to allow closure of the retaining system around the chest of the individual.

According to a further feature of the present invention, the first attachment point and the second attachment point are vertically spaced by no less than 10 cm.

The connecting element includes a sleeve configured for deploying over the back support so as to circumscribe at least part of both the front surface and the rear surface of the back support.

The retaining system includes a seat of a vehicle which is comprised of a horizontal seat portion and an upright portion for supporting the back of an individual sitting in the seat.

The two restraining straps are configured to be deployed to the top half of the upright portion of the seat of the vehicle.

The retaining system additionally includes a lap-belt element of a seat belt transversely spanning the lap of the seated occupant.

The connecting element further includes a lower strap which is connected to or integrally formed into at least two lower tensioning straps and configured to connect to the seat belt transversely spanning the lap of the seated occupant and is configured to pass underneath the seat.

The lower strap is connected to or integrally formed into at least two straps which attach to the lap-belt element of the seat belt transversely spanning the lap of the seated occupant. At least one of the lower strap and the at least two lower tensioning straps is implemented as an elastically stretchable element.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. The invention is herein described, by way of example only, with reference to the accompanying drawings, wherein:

FIG. 1 is a front view of a seat belt for pregnant women in the open position.

FIG. 2 is a front view of a seat belt for pregnant women in the closed position.

FIG. 3 is a front view the present invention in the closed position illustrating the belt worn on an individual seated in a vehicle.

FIG. 4 is a schematic isometric view of a vehicle seat assembly fitted with a restraining device constructed and operative according to a second embodiment of the present invention.

### DESCRIPTION OF THE PREFERRED EMBODIMENTS

The present invention is an individual body-restraining device for protection of an occupant of a transport vehicle and, in particular, it relates to a seat belt designed to protect pregnant women in the event of an automobile accident. The principles and operation of a retaining system according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. This invention is particularly advantageous for a pregnant women but it may be useful for any passengers. Even though passengers seated in automobiles are the main application of this invention but it can be applied to any means of transportation where a passenger is seated on a seat.

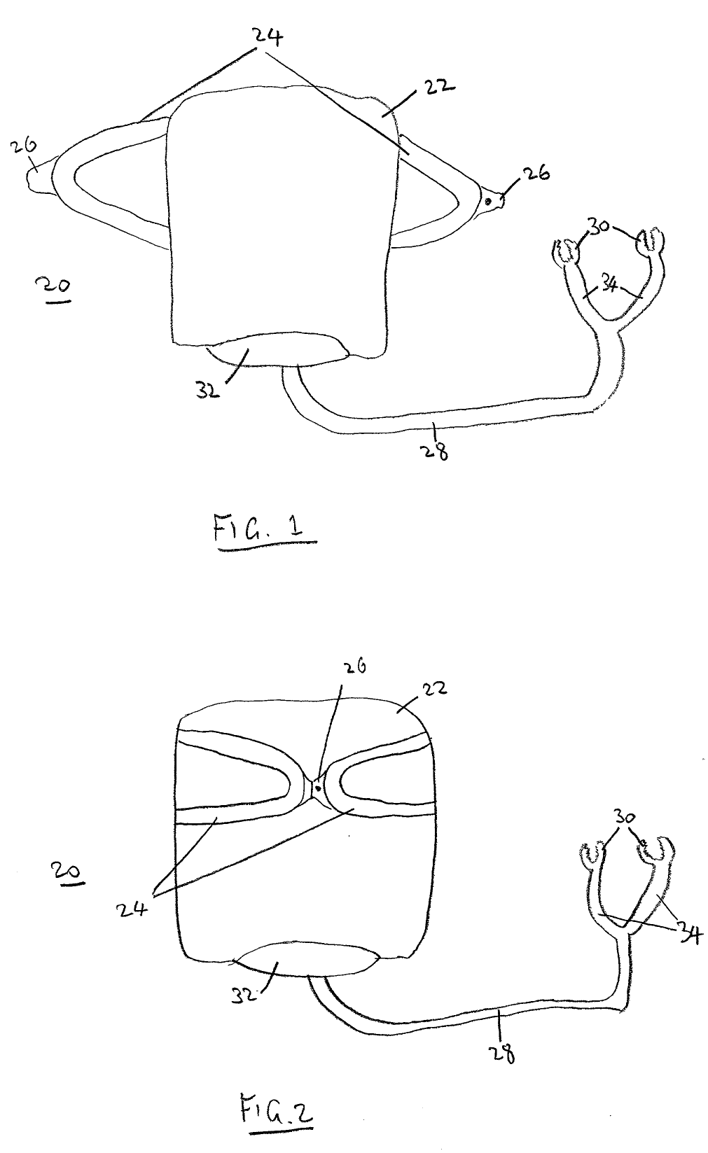

The principles and operation of individual body-restraining device according to the present invention may be better understood with reference to the drawings and the accompanying description. Specifically, a first embodiment of the present invention particularly suited for retrofitting on an existing vehicle seat will be described with reference to FIGS. 1-3, while a second embodiment particularly suited to manufacture as an integral part of a seat will be described with reference to FIG. 4.

Referring now to the drawings, FIG. 1 illustrates a front view of a connecting element 20 in the open condition. A connecting element 20 is shown here in the diagram only for simplicity's sake as this connecting element can be designed to fit many types of seats in many different forms. The connecting element 20 can be integrally formed with, attached to, or added to the vertical portion of a vehicle seat. The preferred embodiments shown here are only examples of numerous forms associated with the individual body-restraining device. The connecting element 20 preferably has a cover 22 which fits over the vertical portion of a vehicle seat. The cover 22 fits over the vertical portion of a vehicle seat by pulling the cover 22 through the opening 32 and pulling it down until it fits tightly over the seat.

Two retaining straps 24 are each connected to the cover 22 at two vertically spaced apart attachment points, thereby avoiding the potentially damaging problems associated with the Grene reference mentioned above. Preferably, the points of attachment are spaced by no less than about 10 cm, and most preferably by 20-30 cm. It should be noted that the phrase “vertically spaced” is used herein to denote two positions which are separated by a vector having a non-zero vertical component. Thus, the phrase “vertically spaced” as used herein does not necessarily, or even typically, imply that the points of attachment are vertically aligned. By way of example, the upper of each pair of attachment points may optionally be located along the upper edge of the seat rather than at the side. Each strap 24 is configured to be deployed at the top half of the upright portion of the seat, forming a loop through which an arm of the individual can be inserted. The catch assembly 26 is connected to the ends of the retaining straps 24. Optionally, one or both of the attachment points on each side may be provided with a recoiling inertial-locking reel assembly of a type known in the art.

According to one variation of the preferred embodiments the connecting element further includes a lower strap 28 which is connected to the rear bottom side of the cover 22. The lower strap 28 then connects to or integrally forms into at least two lower tensioning straps 34 at the ends of which are connectors 30.

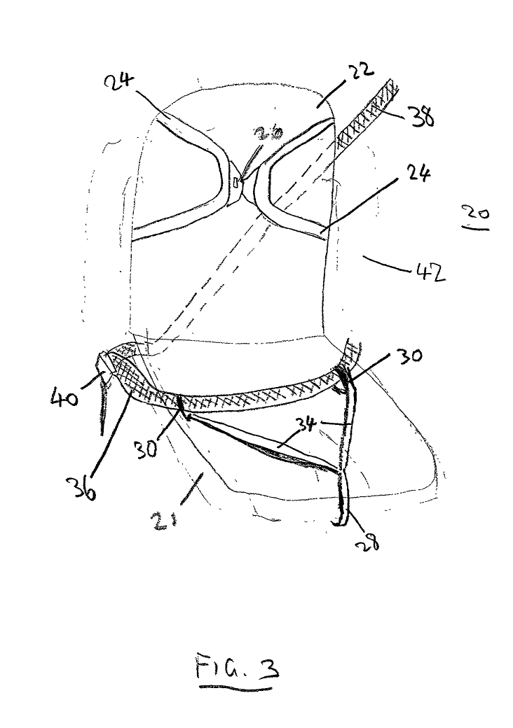

FIG. 2 illustrates the same preferred embodiments of the connecting element 20 shown here with the two retaining straps 24 in the closed position.

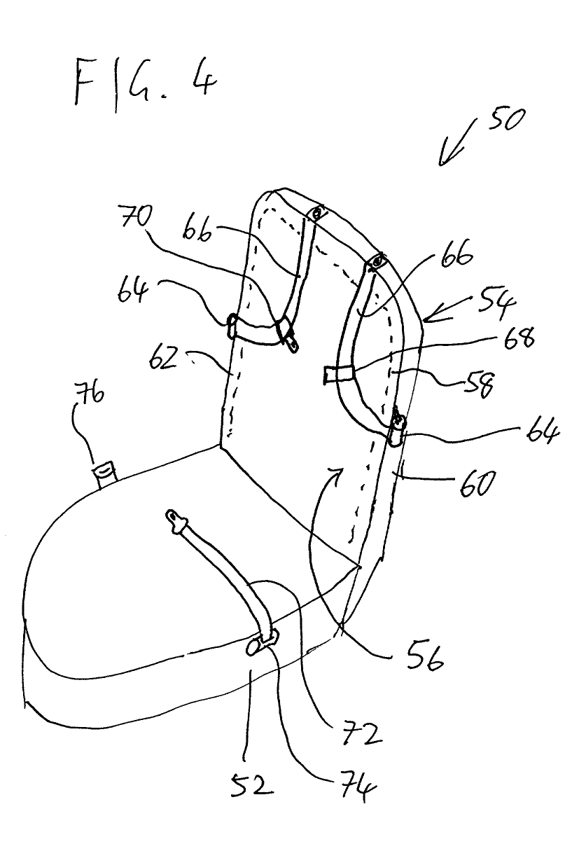

As a non-limiting illustrative example of the above system (FIG. 3) illustrates an individual 42 seated in a vehicle with the present invention in the closed position. The individual is seated on a seat 21. At first, the individual fastens her lap seat belt 36 to a latch 40. As is the case in most automobiles the shoulder strap 38 is an integral part of the seat belt apparatus. After the belt is latched then the shoulder belt 38 is slipped over the head of the individual 42 and falls into place behind the back of the individual.

The two restraining straps 24 are then latched into a closed position by latching the two parts of the catch assembly 26. As the two restraining straps 24 are configured so as to restrain an individual to the top half of the vertical portion of seat of vehicle, this will result in the individual's being restrained around her chest and not anywhere near the abdomen.

The bottom belt 28 is then pulled up from underneath the seat 21 between the legs of the individual and fastened to the lap belt 36 by two connectors 30 which are at the ends of the two straps 34 connected to the end of the bottom strap 28. The tensile force is embedded into the bottom belt 28 by for example having some elasticity built into a portion of the bottom belt 28. The tensile force in effect pulls the lap belt 36 down toward the knees which in effect alleviates the pressure and danger of a lap-belt being positioned too high over the abdomen of a pregnant lady.

Turning now to FIG. 4, there is shown a second embodiment of the present invention particularly suited to production as part of a seat assembly 50. Generally speaking, seat assembly 50 includes a seat 52 having a back support 54 with a front surface 56 against which the individual sits, and a frame 58 having a first side 60 and a second side 62. At least one, and preferably at least two, recoiling inertial-locking reel assemblies 64 are mounted in fixed relation to frame 58. Two retaining straps 66 are each attached to frame 58 at two attachment points which are vertically spaced (although not necessarily vertically aligned, as may be seen in this example) so as to form a loop adjacent to each of first and second sides 60, 62 through which an arm of the individual can be inserted. At least one of the attachment points for each retaining strap is implemented by attachment to a reel assembly 64 so as to provide convenient self-adjusting operation and tidy storage of the straps when not in use. A catch assembly includes at least one, and preferably two, catch portions 68, 70 each attached to one of the retaining straps. The catch assembly is configured for releasably connecting between the two retaining straps 66 so as to allow closure of the retaining system around the chest of the individual.

It will immediately be apparent that this embodiment of the present invention offers a highly effective restraint system for all individuals which replaces the conventional three-point or other conventional restraint system. Additionally, the use of recoiling reel assemblies mounted on the seat itself provides a highly compact and convenient storage configuration which avoids tangling of people or objects in hanging straps. At the same time, the system of the present invention shares all the advantages of the first embodiment in that it provides an effective restraint system with minimum risk of injury to a pregnant woman or her fetus. Thus, here too, the points of attachment are all preferably in the upper half of the seat back. In all other respects, this embodiment is similar to the first embodiment described above and will be fully understood by analogy to the preceding description.

Preferably, the restraint system is supplemented by a lap belt 72, preferably also implemented using at least one recoiling inertial-locking reel assembly 74. Lap belt 72 is attached to the seat base in such a position as to close over the upper thighs of a person sitting on seat 52, thereby also avoiding exertion of pressure on the abdomen of the user. The lap belt typically fastens at a catch mechanism 76.

It will be appreciated that the above descriptions are intended only to serve as examples, and that many other embodiments are possible within the spirit and the scope of the present invention.

What is claimed is:

1. A retaining system for retaining an individual against inertial forces while sitting in a seat of a vehicle, the seat having a back support with a front surface against which the individual sits and a rear surface, the rear surface having a width, the retaining system comprising:
(a) at least one connecting element configured for deploying across the width of the rear surface of the back support, said at least one connecting element including a first side portion and a second side portion;
(b) two retaining straps, each of said retaining straps being connected to or integrally formed with said connecting element at a first attachment point at a first vertical position on one of said first and said second side portions and at a second attachment point vertically spaced from said first attachment point, each of said retaining straps thereby forming a loop through which an arm of the individual can be inserted; and
(c) a catch assembly including at least one catch portion attached to one of said retaining straps, said catch assembly being configured for releasable connecting between said two retaining straps so as to allow closure of the retaining system around the chest of the individual.

2. The retaining system of claim 1, wherein said at least one connecting element includes a sleeve configured for deploying over the back support so as to circumscribe at least part of both the front surface and the rear surface of the back support.

3. The retaining system of claim 1, further comprising a seat of a vehicle which is comprised of a horizontal seat portion and an upright portion for supporting the back of an individual sitting in said seat.

4. The retaining system of claim 3, wherein said two restraining straps are configured to be deployed to the top half of said upright portion.

5. The retaining system of claim 3, further comprising a lap-belt element of a seat belt transversely spanning the lap of the seated occupant.

6. The retaining system of claim 5, wherein said connecting element further comprises a lower strap.

7. The retaining system of claim 6, wherein said lower strap is connected to or integrally formed with at least two lower tensioning straps.

8. The retaining system of claim 7, wherein said at least two lower tensioning straps is configured to connect to said seat belt transversely spanning the lap of the seated occupant.

9. The retaining system of claim 7, wherein said lower strap passes underneath the seat.

10. The retaining system of claim 7, wherein at least one of said lower strap and said at least two lower tensioning straps is implemented as an elastically stretchable element.

11. The retaining system of claim 1, wherein said first attachment point and said second attachment point are vertically spaced by no less than 10 cm.

12. A vehicle seat assembly including a retaining system for retaining an individual against inertial forces while sitting in the seat, the seat assembly comprising:
(a) a seat having a back support with a front surface against which the individual sits, said back support including a frame having a first side and a second side;
(b) at least one recoiling inertial-locking reel assembly mounted in fixed relation to said frame;
(c) two retaining straps, each of said retaining straps being attached to said frame at two vertically spaced attachment points so as to form a loop associated with one of said first and second sides through which an arm of the individual can be inserted, at least one of said attachment points for each of said retaining straps being implemented by attachment to said at least one reel assembly; and
(d) a catch assembly including at least one catch portion attached to one of said retaining straps, said catch assembly being configured for releasable connecting between said two retaining straps so as to allow closure of the retaining system around the chest of the individual.

13. The vehicle seat assembly of claim 12, wherein all of said attachment points are located in an upper half of said back support.

14. The vehicle seat assembly of claim 12, further comprising a lap belt attached to said seat and configured to close over the upper thighs of the individual sitting in the seat.
